(19) United States
(12) Patent Application Publication
(10) Pub. No.: US 2012/0319898 A1
(43) Pub. Date: Dec. 20, 2012

(54) METHOD OF DETECTING MULTIPATH, GNSS RECEIVING APPARATUS , AND MOBILE TERMINAL

(75) Inventors: Takaki Tominaga, Nishinomiya-City (JP); Takuji Yasumoto, Nishinomiya-City (JP)

(73) Assignee: FURUNO ELECTRIC COMPANY LTD., Nishinomiya-City, Hyogo-Pref. (JP)

(21) Appl. No.: 13/581,260

(22) PCT Filed: Feb. 23, 2011
(86) PCT No.: PCT/JP2011/054025

§ 371 Date: Aug. 24, 2012

(30) Foreign Application Priority Data
Feb. 26, 2010 (JP) 2010-042855

(51) Int. Cl. G01S 19/22

(52) U.S. Cl. 342/357.61

(57) ABSTRACT

An existence of multipath is detected accurately based on not only a C/No. A C/No (iv) of a reception signal, a pseudorange PR(iv), and a delta range DR(iv) are acquired (S101). First, as determination processing based on individual measurement values, thresholds are set thereto respectively, and the existence of multipath is detected (S102-S104). Next, as determination processing based on continuous values, an average value C/No(Av) and a standard deviation σ_{C/No} of the C/No, and an average value DV(Av) and a standard deviation σ_{DV} of the difference values are calculated, thresholds are similarly set thereto respectively, and the existence of multipath is determined (S105-S109). Then, if multipath is determined that it does not exist based on the individual measurement values and the continuous values, it is determined ultimately that multipath does not exist (S110).

### TECHNICAL FIELD

The present invention relates to a method of detecting multipath that is caused when receiving positioning signals from GNSS satellites.

### BACKGROUND ART

Conventionally, many positioning apparatuses for receiving positioning signals from GNSS satellites and performing a positioning have been put into practical use. With such positioning apparatuses, an accurate positioning can be performed by directly receiving positioning signals transmitted from GNSS satellites. However, when a tall construction and the like exist near the positioning apparatus, such as in an urban area, the positioning apparatus receives direct positioning signals from GNSS satellites as well as indirect positioning signal(s) which were reflected on, for example, the tall construction, and an error occurs in a pseudorange to be calculated. Such an error is referred to as a multipath error, and various methods of detecting and removing the multipath have been devised conventionally.

For example, in the invention of Patent Document 1, if a peak in code correlation is detected in performing code correlation processing of positioning signals, a peak is sought again in a past direction on a phase axis, and if a higher peak than the peak detected first exists, the peak detected first is determined as the peak generated due to multipath.

Further, in the invention of Patent Document 2, with respect to a C/No of the reception signal of the GNSS satellite with the largest elevation angle, a threshold of the C/No is determined, and the reception signal(s) of a C/No below the C/No of the threshold is determined as the reception signal(s) due to multipath.

Further, in the invention of Patent Document 3, a current approximate pseudorange is calculated based on a previous estimated pseudorange, and if a difference value between the approximate pseudorange and a current estimated pseudorange is above a threshold, it is determined that multipath exists.

### REFERENCE DOCUMENTS OF CONVENTIONAL ART

### Patent Documents

Patent Document 1: JP1994-066912A

Patent Document 2: JP2003-149315A

Patent Document 3: JP2003-057327A

### DISCLOSURE OF THE INVENTION

### Problems to be Solved by the Invention

However, with the invention of Patent Document 1, even if multipath does not exist, after the correlation peak is detected, search of another peak is required to be performed in a past direction on the phase axis. Further, with the invention of Patent Document 2, it is concerned that cases where, for example, the C/No of the GNSS satellite with the largest elevation angle is low or the C/No of multipath may occur, and it is not curtain that multipath can be detected accurately. Further, in Patent Document 3, in addition to normal pseudorange estimation processing, processing of calculating the approximate pseudorange is required to be performed based on the previous estimated pseudorange and a previous estimated relative speed only to perform the determination of multipath, which causes processing load to increase.

The present invention aims to realize a multipath detecting device and a method of detecting multipath, in which multipath can be detected further accurately by using normal correlation processing results and suppressing influence caused by unstability of C/No.

### SUMMARY OF THE INVENTION

The present invention relates to a method of detecting multipath by outputting a detection signal indicating that a multipath signal is included in reception signals of GNSS positioning signals. The multipath detecting method includes calculating a pseudorange based on a code phase difference of the reception signals, measuring a Doppler shift of the reception signals, and outputting the detection signal based on a change rate of the pseudorange within a predetermined period of time and the Doppler shift.

Further, the present invention relates to a method of detecting multipath by outputting a detection signal indicating that a multipath signal is included in reception signals of GNSS positioning signals. The multipath detecting method includes calculating a pseudorange based on a code phase difference of the reception signals, measuring a Doppler shift of the reception signals, measuring a C/No of the reception signals, and outputting the detection signal based on a change rate of the pseudorange within a predetermined period of times, the Doppler shift, and the C/No.

Although the detail is described in embodiments, these methods are achieved with the focus on the following respective features.

(1) A time transition of the C/No and a time transition of the pseudorange are greatly different between in a period where multipath occurs and in a period where multipath does not occur.

(2) A time transition of a Doppler frequency hardly changes regardless of whether being within the period where multipath occurs or in the period where multipath does not occur.

(3) A time change of the pseudorange which can be obtained based on the time transition of the pseudorange, and the delta range can be treated in the same dimension (unit of speed).

By calculating the difference value between the time change of the pseudorange that is easily influenced by multipath and the delta range that is difficult to be influenced by multipath through using these features, the difference value serves as data dependant only to multipath.

Therefore, by using the difference value, the existence of multipath can be determined accurately. Further, by using the level of the C/No, a further accurate determination of the existence of multipath can also be performed.

Further, the outputting the detection signal may include outputting the detection signal when at least one of a difference value between the change rate of the pseudorange within the predetermined period of time and the Doppler shift, an average value of the difference values, and a standard deviation of the difference values is above a threshold based on the C/No.

Further, the threshold based on the C/No may be a value based on the standard variation of the difference values corresponding to the C/No measured in advance.

Further, the outputting the detection signal may include outputting the detection signal when at least one of the C/No, a average value of the C/No, and a standard deviation of the C/No is above a predetermined value.

In these methods, further specific multipath detection methods are indicated. For example, the threshold based on the C/No is used in the multipath detection based on the difference value. This method uses that the pseudorange has a tendency that it is more stably calculated as the C/No is higher, and the difference value has a tendency that it is reduced as the C/No is higher. Thus, by setting the threshold of the difference value according to the C/No, multipath can be detected in higher accuracy.

### Effect of the Invention

According to this invention, a multipath reception signal among reception signals of arriving GNSS positioning signals can be detected accurately.

### BRIEF DESCRIPTION OF THE DRAWINGS

FIGS. 1(A) and 1(B) are charts illustrating multipath detection concepts of the invention.

FIG. 2 is a flowchart of a multipath detecting method of a first embodiment.

FIGS. 3(A) and 3(B) are charts illustrating an example of experiment results for obtaining a coefficient for determining a determination threshold DVth(iv) of multipath for a difference value DV(iv).

FIG. 4 is a chart illustrating an example of results of multipath detection by individual measurement values when the method of the embodiment is used.

FIG. 5 is a block diagram illustrating a main configuration of a multipath detecting function system of the first embodiment.

FIG. 6 is a flowchart of a multipath detecting method of a second embodiment.

FIG. 7 is a flowchart of a multipath detecting method of a third embodiment.

FIG. 8 is a flowchart of a multipath detecting method of a fourth embodiment.

FIG. 9 is a block diagram illustrating a main configuration of a mobile terminal 100 including a multipath detecting function system of the invention.

### MODE OF CARRYING OUT THE INVENTION

A method of detecting multipath and a multipath detecting function system according to a first embodiment of the invention is described with reference to the drawings. Note that, in this embodiment, although a GPS of a GNSS is exemplary described, the method and configuration of this embodiment can also be applied to other similar positioning systems.

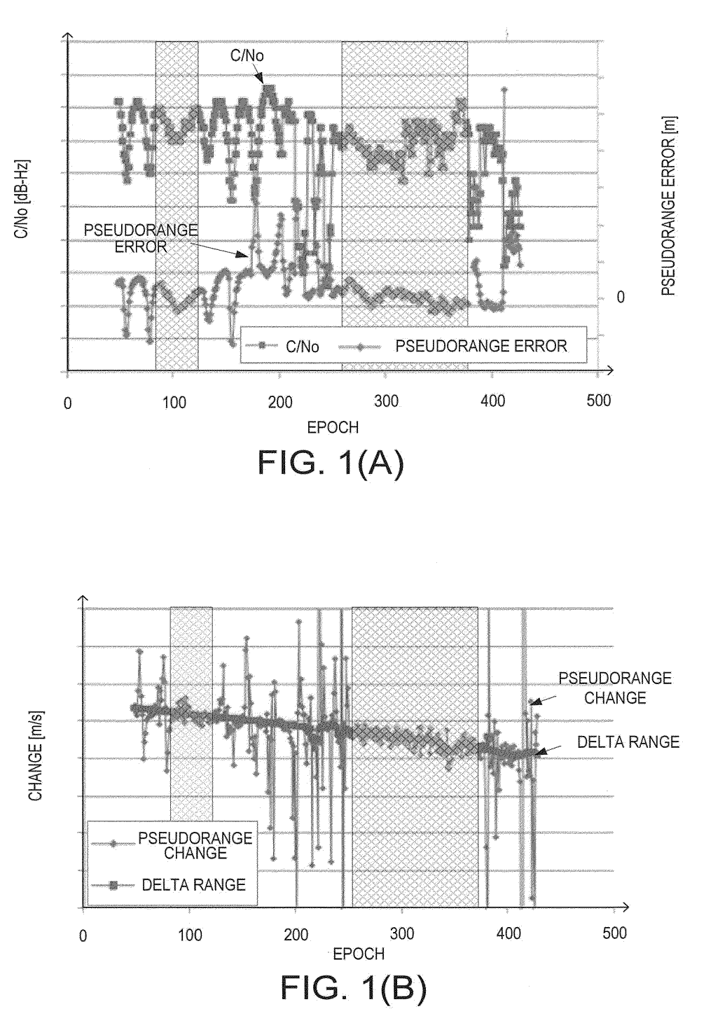

First, a concept of detecting multipath of the invention is described with reference to FIGS. 1(A) and 1(B). FIGS. 1(A) and 1(B) are charts illustrating multipath detection concepts of the invention, in which FIG. 1(A) is the chart showing a time transition of a C/No and a pseudorange error when a GPS signal from a specific single GPS satellite is received with time, and FIG. 1(B) is the chart showing a time transition of a pseudorange change and a delta range under the same condition as FIG. 1(A). This experiment is performed under a condition that the position of the own device, that is a true pseudorange, is in a well-known state. Note that, the delta range is an amount corresponding to a Doppler shift.

Here, a pseudorange error Error(PR(iv)) in FIG. 1(A) is a difference value between a pseudorange PR(iv) and the true pseudorange at each count (epoch) timing. The pseudorange PR(iv) is calculated based on a result of integrating code correlation results of the reception signals for a predetermined time length (e.g., for 1 second) toward the past based on each count timing.

A C/No (iv) in FIG. 1(A) is calculated based on the result of integrating the correlation results obtained by a two-dimensional correlation spectrum of the reception signals for a predetermined time length (e.g., for 1 second) toward the past based on each count timing. Note that, in this embodiment, although an example using correlation results based on the two-dimensional correlation spectrum configured with correlation values on a code axis and correlation values on a frequency axis is shown, it may be other correlation results.

A pseudorange change Rr(iv) in FIG. 1(B) is calculated based on a difference between a pseudorange PR(iv)ₙ at each count timing and a pseudorange PR(iv)ₙ₊₁ at an immediate previous count timing of the count timing.

A delta range DR(iv) in FIG. 1(B) is calculated by integrating Doppler frequencies of the reception signals for a predetermined time length (e.g., for 1 second) based on the respective count timings.

Moreover, as shown in the hatched part of FIG. 1(A), in the time ranges where the count (cnt) is between about 80 and 120 and between about 250 and 360, the pseudorange error Error(PR(iv)) is approximately “0”, and it is considered to be highly possible that multipath is not caused in those time ranges but more than a low level of multipath occurs in other time ranges. Based on this point, the C/No (iv) stabilizes in the time range where multipath does not occur and it varies significantly in the time range where multipath occurs.

Here, as shown in FIG. 1(B), it can be understood that the pseudorange change Rr(iv) also stabilizes in the time range where multipath does not occur and it varies significantly in the time range where multipath occurs.

On the other hand, as shown in FIG. 1(B), the delta range DR(iv) is steady regardless of the occurrence of multipath. This is considered because the delta range depends on the Doppler frequency and thus it is not influenced by the occurrence of multipath.

Here, because the pseudorange change Rr(iv) is indicated by a change of distance in time, that is a unit of speed, and the delta range DR(iv) is a value that is an integrated value of the Doppler frequencies indicated by the unit of speed, they can simply be used in four operations. By using this, a difference value DV(iv) is calculated through reducing the pseudorange change Rr(iv) by the delta range DR(iv). Because this difference value DV(iv) is a difference value between the pseudorange change Rr(iv) and the delta range DR(iv), it is substantially the same in the time range where the pseudorange change Rr(iv) is stable and multipath does not occur, and it varies significantly in the time range where the pseudorange change Rr(iv) is unstable and multipath occurs.

Further, as shown in FIG. 1(B), the pseudorange change Rr(iv) and the delta range DR(iv) have the same transition tendency of value in time transition. Therefore, the difference value DV(iv) becomes a value such that the pseudorange change Rr(iv) is standardized by the delta range DR(iv). In this manner, influence due to external factors other than multipath is suppressed and the time transition of the pseudorange change Rr(iv) can be observed.

Upon discovering these characteristics, multipath is detected based on the following terms in this embodiment.

(1) a C/No(iv), an average value C/No(Av) calculated by using a plurality of the C/No(iv), and a standard deviation σ_{C/No}.

(2) a difference value DV(iv) between the pseudorange change and the delta range, an average value DV(Av) calculated by using a plurality of the difference values DV(iv), and a standard deviation σ_{DV}.

Thresholds obtained experimentally are set for these values respectively, and multipath is determined to exist when multipath detecting conditions based on the thresholds are satisfied, and multipath is determined to not exist when multipath detecting conditions based on the thresholds are not satisfied.

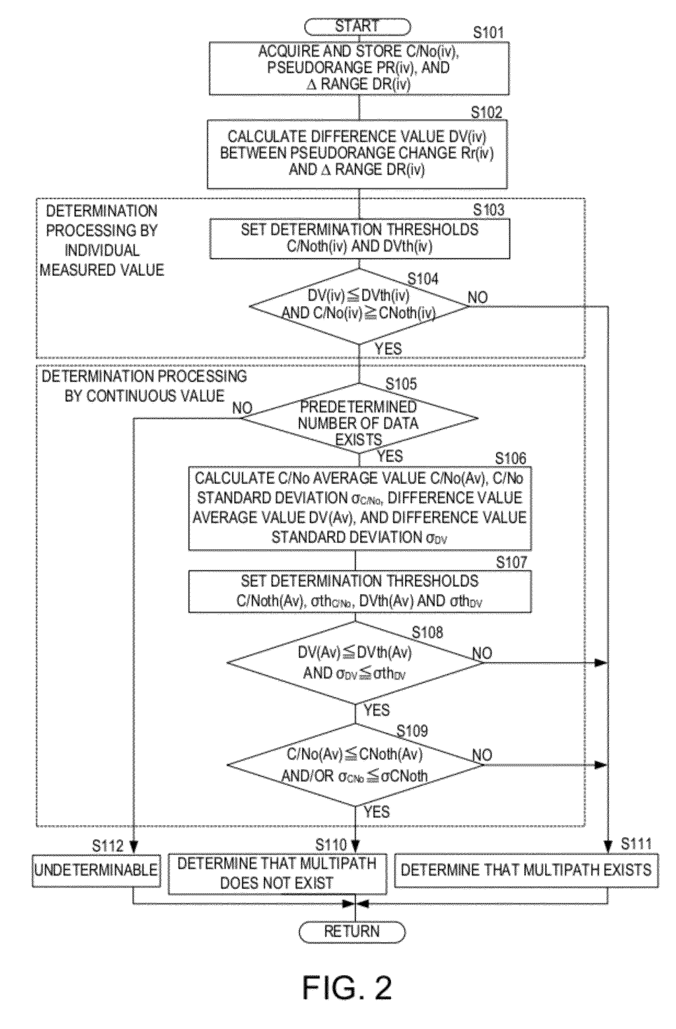

Next, the specific multipath detecting method of this embodiment is described with reference to FIG. 2. FIG. 2 is a flowchart of the multipath detecting method of this embodiment.

First, in the multipath detecting method of this embodiment, the C/No (iv), the pseudorange PR(iv), and the delta range DR(iv) are acquired at every count timing (e.g., every second) to be stored (S101). Here, the C/No (iv) is calculated based on the correlation result obtained by the two-dimensional correlation spectrum obtained during the period between the count timings as described above (e.g., for 1 second), that is a correlation data distribution in the code phase axis and a correlation data distribution in the frequency axis. The pseudorange PR(iv) is calculated based on the code phase difference obtained during the period between the count timings as described above (e.g., for 1 second) by using a well-known method. The delta range DR(iv) is calculated by integrating the Doppler frequencies that are respectively obtained from carrier phase differences obtained during the period between the count timings as described above (e.g., for 1 second).

Next, the pseudorange change Rr(iv) is obtained by finding the difference between the pseudorange PR(iv) and an immediate previous pseudorange PR(iv) thereof. Further, a difference operation between the calculated pseudorange change Rr(iv) and the delta range DR(iv) is performed to calculate and store the difference value DV(iv) (S102).

Next, a multipath determination threshold C/Noth(iv) for the C/No (iv) is set. The determination threshold C/Noth(iv) is a value that is suitably set based on a specification of the apparatus, an observation result and experiment results in the past. Further, based on the observed C/No (iv), a multipath determination threshold DVth(iv) for the difference value DV(iv) is set by using the following equation (S103).

$$D Vth ( iv ) = {a}_{0} + {a}_{1} \cdot {e}^{- ( \frac{C / No ( iv )}{a 2} )}$$

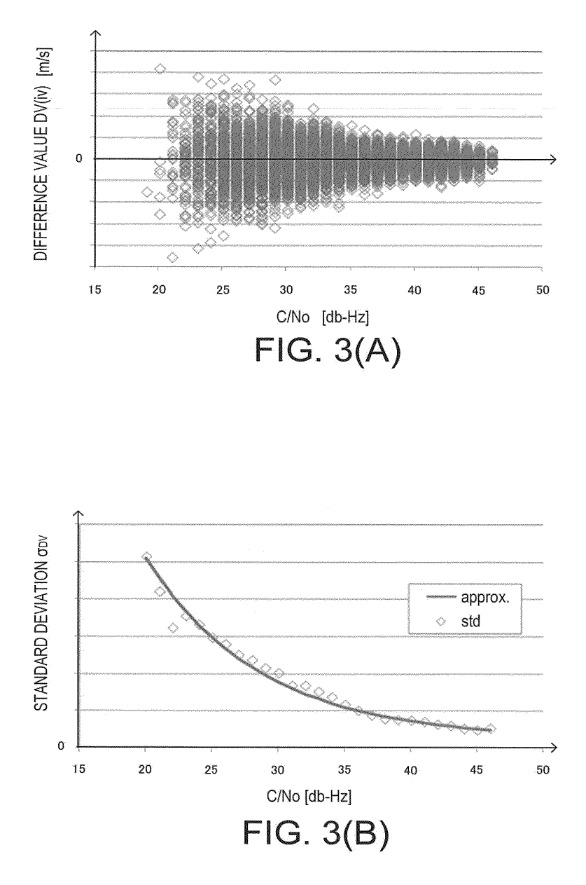

Here, the respective coefficients a₀, a₁, and a₂ are determined based on an experiment result illustrated in FIGS. 3(A) and 3(B).

FIG. 3(A) is a chart illustrating an example of experiment results for obtaining the coefficient for determining the multipath determination threshold DVth(iv) for the difference value DV(iv), and a relation between the difference value DV and the C/No is illustrated. FIG. 3(B) illustrates a relation between the standard deviation of the difference value DV and the C/No, in which a rhombic symbol indicates the standard deviation at each C/No illustrated in FIG. 3(A), and the solid line indicates an approximate curve. Each of the coefficients a₀, a₁, and a₂ are set based on the approximate curve.

As illustrated in FIGS. 3(A) and 3(B), the difference value DV varies greater and has a larger absolute maximum value as the C/No reduces. On the other hand, the difference value DV has a smaller absolute maximum value and approaches “0” as the C/No increases. Moreover, the difference value DV is reduced exponentially as the C/No increases.

By determining the determination threshold DVth(iv) based on this experimental result, the threshold according to the C/No can be set, and the occurrence of multipath can be performed accurately even under a circumstance where, for example, multipath occurs even if the C/No is high or multipath does not occur even if the C/No is low. Note that, this coefficient can be suitably and finely adjusted based on the specification of multipath detection, etc.

Next, the C/No (iv) and the determination threshold C/Noth(iv) are compared to each other, and the difference value DV(iv) and the determination threshold DVth(iv) are compared to each other. Moreover, if the C/No (iv) is above the determination threshold C/Noth(iv) and the difference value DV(iv) is below the determination threshold DVth(iv), in the determination by the individual measurement values, it is determined that multipath does not exist (S104: YES).

On the other hand, when either one of a condition in which the C/No (iv) is below the determination threshold C/Noth(iv) and a condition in which the difference value DV(iv) is above the determination threshold DVth(iv) is satisfied, it is determined that multipath exists (S104: NO→S111).

Next, when the multipath determination by the individual measurement values is finished, a multipath determination by continuous values is performed. First, it is determined whether predetermined numbers of data of C/No (iv) and the difference values DV(iv) are acquired, respectively. Thus, it is determined whether the numbers of data corresponding to the sampling numbers for calculating the average value C/No(Av) and the standard deviation σ_{C/No} of the C/No and the average value DV(Av) and the standard deviation σ_{DV} of the difference values exist, respectively. Here, if the predetermined numbers of data cannot be acquired, it is defined to be indeterminable (S105: NO→S112).

On the other hand, if the predetermined numbers of data can be acquired (S105: YES), the average value C/No(Av) and the standard deviation σ_{C/No} of the C/No and the average value DV(Av) and the standard deviation σ_{DV} of the difference values are calculated (S106).

Next, a multipath determination threshold C/Noth(Av) for the average value C/No(Av) of the C/No and a multipath determination threshold σth_{C/No} for the standard deviation σ_{C/No} are set (S107). These determination thresholds C/Noth(Av) and σth_{C/No} are set suitably based on the specification of the apparatus, and observation results and experiment results in the past, similar to the determination threshold C/No(iv) described above. Further, a determination threshold DVth(Av) of the average value of the difference values and a determination threshold σth_{DV} of the standard deviation of the difference values are set similarly to the determination threshold DVth(iv) described above. These values may be the same or may be set to have a relation of constant multiplication with respect to each other.

Next, the average value DV(Av) of the difference values and the determination threshold DVth(Av) are compared to each other, and as well as the standard deviation σ_{DV} of the difference values and the determination threshold σth_{DV} are compared to each other. Further, if the average value DV(Av) of the difference values is below the determination threshold DVth(Av) thereof and the standard deviation σ_{DV} of the difference values is also below the determination threshold σth_{DV} thereof, it is determined that multipath does not exist based on the determination by the average value and the standard deviation of the difference values (S108: YES). On the other hand, if the average value DV(Av) of the difference values is above the determination threshold DVth(Av) thereof or the standard deviation σ_{DV} of the difference values is above the determination threshold σth_{DV} thereof, it is determined that multipath exists (S108: NO→S111).

Next, the average value C/No(Av) and the determination threshold C/Noth(Av) of the C/No are compared to each other, and as well as the standard deviation σ_{C/No} and the determination threshold σth_{C/No} of the C/No are compared to each other. Further, if the average value C/No(Av) of the C/No is below the determination threshold C/Noth(Av) thereof or the standard deviation σ_{C/No} of the C/No is below the determination threshold σth_{C/No} thereof, it is determined that multipath does not exist based on the average value and the standard deviation of the C/No (S109: YES) and ultimately it is determined that multipath does not exist (S110). On the other hand, if this condition is not satisfied, it is determined that multipath exists (S109: NO→S111).

By performing such processing, the existence of multipath can accurately be detected.

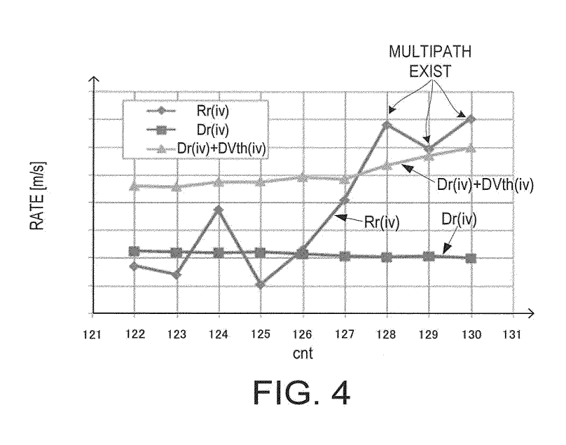

For example, FIG. 4 is a chart illustrating an example of results of multipath detection by the individual measurement values when the method of this embodiment is used. FIG. 4 indicates a temporal border of a shift from the count timing 121 to 128 in FIG. 1 described above, that is, from the range with no multipath to the range with multipath, in which the vertical axis indicates a unit of speed and each rhombic symbol indicates the pseudorange change Rr(iv), each square symbol indicates the delta range Dr(iv), and the triangle symbol indicates a value obtained by adding the determination threshold DVth(iv) of the difference value DV(iv) to the delta range Dr(iv).

As shown in FIG. 4, by using the multipath detecting method of this embodiment, it is determined that multipath exists at the count timing 128. Here, although the C/No satisfies the condition for no multipath, because it is determined that multipath exists due to the difference value DV(iv) as above, the detection result shows that multipath exists. Thus, by using the multipath detecting method of this embodiment, multipath can be detected further finely.

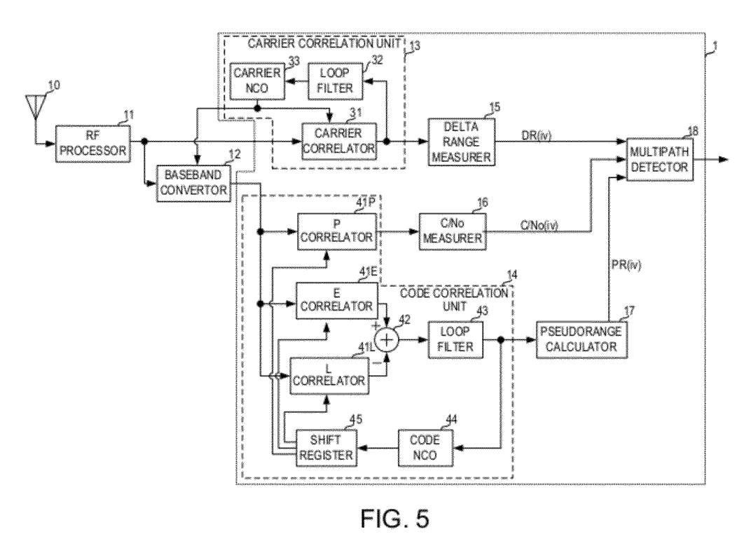

Next, the configuration of the system for achieving such multipath detection is described with reference to a drawing. FIG. 5 is a block diagram illustrating a main configuration of the multipath detecting function system of this embodiment.

As shown in FIG. 5, the multipath detecting function system 1 of this embodiment includes a carrier correlation unit 13, a code correlation unit 14, a delta range measurer 15, a C/No measurer 16, a pseudorange calculator 17, and a multipath detector 18. Although an example of configuring the carrier correlation unit 13 and the code correlation unit 14 in separate loops is shown in this embodiment, a so called code-carrier integrated tracking loop in which a so called code correlation result is used in carrier correlation processing and the carrier correlation result is used in code correlation processing.

These carrier correlation unit 13 and the code correlation unit 14 are connected with a baseband convertor 12. The baseband converter 12 is inputted with an IF signal obtained through down-converting a GPS signal received by an antenna 10 to an intermediate frequency by an RF processor 11. The baseband converter 12 uses a carrier frequency signal from a carrier NCO 33 of the carrier correlation unit 13 to convert the IF signal into a code signal of the baseband and outputs it to the code correlation unit 14.

The carrier correlation unit 13 includes a carrier correlator 31, a loop filter 32, and the carrier NCO 33. The carrier correlator 31 multiplies the carrier frequency signal from the carrier NCO 33 by the IF signal of the RF processor 11 and outputs a carrier phase difference therebetween. The outputted carrier phase difference is fed back to the carrier NCO 33 via the loop filter 32. Further, the carrier phase difference is also outputted to the delta range measurer 15.

The code correlation unit 14 includes a P correlator 41P, an E correlator 41E, an L correlator 41L, an adder 42, a loop filter 43, a code NCO 44, and a shift register 45.

The code correlation unit 14 is a correlation unit for performing code tracking by performing a so called Early-Late correlation.

The P correlator 41P multiplies a Punctual replica code by the code signal from the baseband convertor 12 and outputs Punctual phase difference data. The E correlator 41E multiplies an Early replica code of which a code phase is ½ chip ahead of the Punctual replica code by the code signal from the baseband convertor 12 and outputs Early phase difference data. The L correlator 41L multiplies a Late replica code of which a code phase is ½ chip behind the punctual replica code by the code signal from the baseband convertor 12 and outputs Late phase difference data. Note that, in this description, although each phase difference among the Early, Punctual and Late is set to ½ chip, it may suitably be set according to the situation.

The adder 42 finds a difference between the Early phase difference data and the Late phase difference data, and creates E-L correlation data. The E-L correlation data is fed back to the code NCO 44 via the loop filter 43 as well as outputted to the pseudorange calculator 17.

The code NCO 44 creates a replica code based on the E-L correlation data, and outputs it to the shift register 45. The shift register 45 creates an Early replica code, a Punctual replica code, and a Late replica code of which the code phases vary by ½ chip from each other, based on the replica code from the code NCO 44. The punctual replica code is outputted to the P correlator 41P, the Early replica code is outputted to the E correlator 41E, and the Late replica code is outputted to the L correlator 41L in synchronization thereto, respectively.

The delta range measurer 15 calculates the delta range DR(iv) by calculating the Doppler frequency based on the carrier phase difference and integrating the predetermined time length of the Doppler frequencies (e.g., for 1 second).

The C/No measurer 16 stores the Punctual phase difference data from the code correlation unit 14 for the predetermined time length (e.g., for 1 second), performs frequency conversion processing, such as FFT processing, on a plurality of stored Punctual phase difference data aligned on a time axis, and measures the C/No (iv) based on the two-dimensional correlation spectrum configured with a spectrum on the time axis and the spectrum on a frequency axis.

The pseudorange calculator 17 calculates the pseudorange PR(iv) by a well-known method based on the E-L correlation data from the code correlation unit 14.

The multipath detector 18 calculates the difference value DV(iv) as described above, based on the delta range DR(iv) from the delta range measurer 15 and the pseudorange PR(iv) from the pseudorange calculator 17. The multipath detector 18 performs the multipath determination by the individual measurement values based on the difference value DV(iv) and the C/No (iv) from the C/No measurer 16, and performs the multipath determination by the continuous values based on the average value DV(Av) and the standard deviation σ_{DV} of the difference values, the average value C/No(Av) of the C/No, and the standard deviation σ_{C/No} of C/No which are obtained from the difference value DV(iv) and the C/No (iv).

By having such a configuration, the multipath detecting function system 1 of executing the multipath detecting method described above can be achieved.

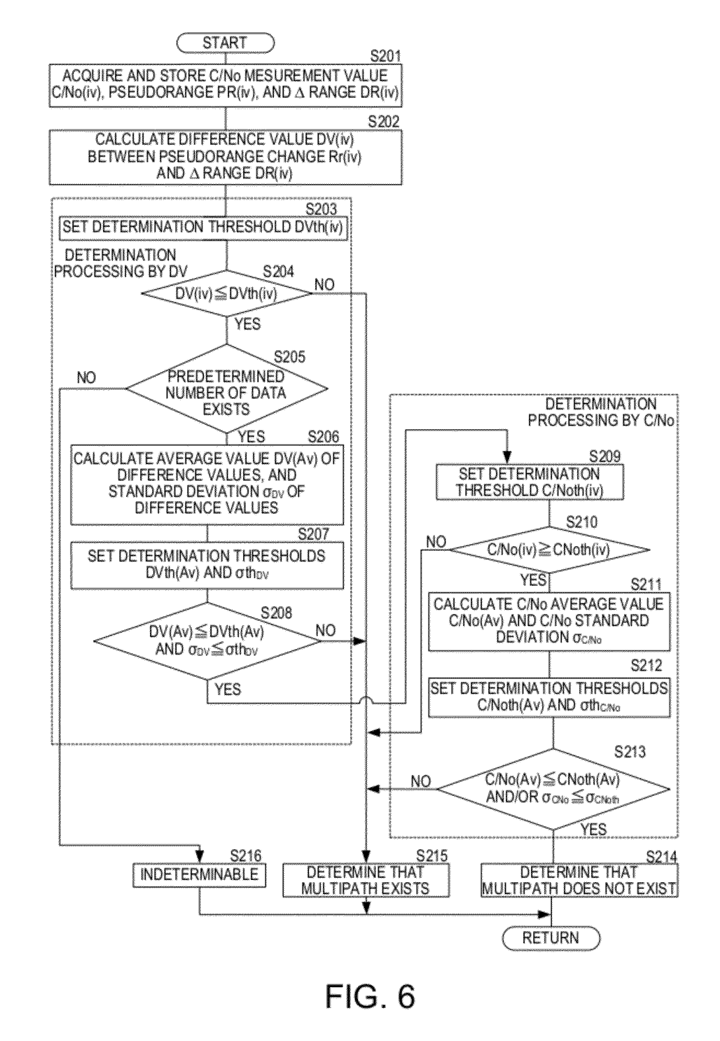

Note that, in the embodiment described above, the example that the multipath determination based on the continuous values are performed after the multipath determination based on the individual measurement values is shown. However, alternatively, as illustrated in FIG. 6, a multipath determination based on the C/No may be performed after a multipath determination based on the difference value DV. FIG. 6 is a flowchart of another multipath detecting method of a second embodiment.

Also in this detecting method, first, the C/No (iv), the pseudorange PR(iv), and the delta range DR(iv) are acquired at every count timing (e.g., every second) to be stored (S201), similar to the first embodiment.

Next, the pseudorange change Rr(iv) is obtained by finding the difference between the pseudorange PR(iv) and an immediate previous pseudorange PR(iv) thereof. Further, a difference operation between the calculated pseudorange change Rr(iv) and the delta range DR(iv) is performed to calculate and store the difference value DV(iv) (S202).

Subsequently, the multipath determination based on the difference value DV is performed firstly. To start, a multipath determination threshold DVth(iv) for the difference value DV(iv) is set based on the measured C/No (iv) similarly to the first embodiment (S203).

Next, the difference value DV(iv) and the determination threshold DVth(iv) are compared to each other, and if the difference value DV(iv) is below the determination threshold DVth(iv), it is determined that multipath does not exist (S204: YES). On the other hand, if the difference value DV(iv) is above the determination threshold DVth(iv), it is determined that multipath exists (S204: NO→S215).

Next, when the multipath determination based on the difference value DV(iv) is finished, the determination based on continuous values is performed. First, it is determined whether a predetermined number of data of the difference values DC(iv) is acquired. Thus, it is determined whether the number of data corresponding to the sampling number for calculating the average value DV(Av) and the standard deviation σ_{DV} of the difference values exists. Here, if the predetermined number of data cannot be acquired, it is defined to be indeterminable (S205: NO→S216).

On the other hand, if the predetermined number of data can be acquired (S205: YES), the average value DV(Av) and the standard deviation σ_{DV} of the difference values are calculated (S206).

Further, a determination threshold DVth(Av) of the average value of the difference values and a determination threshold σth_{DV} of the standard deviation are set similarly to the determination threshold DVth(iv) described above (S207).

Next, the average value DV(Av) of the difference values and the determination threshold DVth(Av) are compared to each other, and as well as the standard deviation σ_{DV} of the difference values and the determination threshold σth_{DV} are compared to each other. Further, if the average value DV(Av) of the difference values is below the determination threshold DVth(Av) thereof and the standard deviation σ_{DV} of the difference values is also below the determination threshold σth_{DV} thereof, it is determined that multipath does not exist and shifts to the determination based on the C/No (S208: YES). On the other hand, if the average value DV(Av) of the difference values is above the determination threshold DVth(Av) thereof or the standard deviation σ_{DV} of the difference values is above the determination threshold σth_{DV} thereof, it is determined that multipath exists (S208: NO S215).

A multipath determination threshold C/Noth(iv) for the C/No (iv) is set similarly to the method in the first embodiment (S208).

Next, the C/No(iv) and the determination threshold C/Noth(iv) are compared to each other, and if the C/No(iv) is above the determination threshold C/Noth(iv), it is determined that multipath does not exist (S210: YES).

On the other hand, if the C/No(iv) is below the determination threshold C/Noth(iv), it is determined that multipath exists (S210: NO→S215).

Next, when the multipath determination based on the individual measurement values is finished, the multipath determination based on the continuous values is performed. First, an average value C/No(Av) and a standard deviation σ_{C/No} of the C/No are calculated (S211).

Next, a multipath determination threshold C/Noth(Av) for the average value C/No(Av) of the C/No and a multipath determination threshold σth_{C/No} for the standard deviation σ_{C/No} are calculated.

Subsequently, the average value C/No(Av) and the determination threshold C/Noth(Av) of the C/No are compared to each other, and as well as the standard deviation σ_{C/No} and the determination threshold σth_{C/No} of the C/No are compared to each other. Further, if the average value C/No(Av) of the C/No is below the determination threshold C/Noth(Av) thereof or the standard deviation σ_{C/No} of the C/No is below the determination threshold σth_{C/No} thereof, it is determined that multipath does not exist based on the determination by the average value and the standard deviation of the C/No (S213: YES) and ultimately it is determined that multipath does not exist (S214). On the other hand, if this condition is not satisfied, it is determined that multipath exists (S213: NO→S215).

Also with such a method, the existence of multipath can be detected accurately.

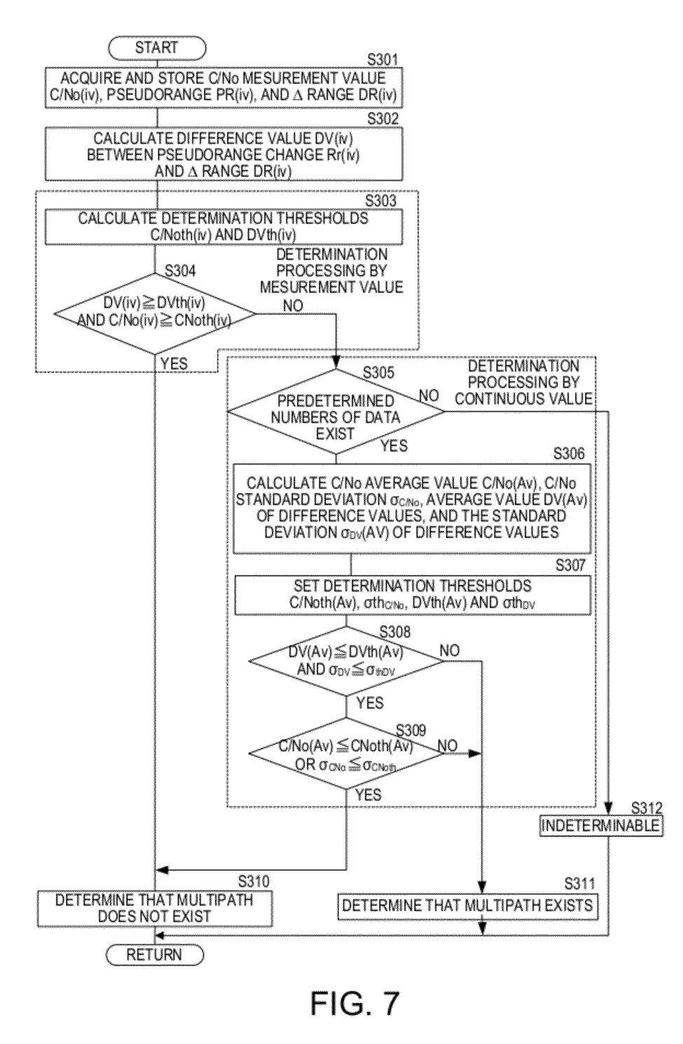

Next, a multipath detecting method according to a third embodiment is described with reference to a drawing. FIG. 7 is a flowchart of the multipath detecting method of this embodiment.

Steps S301 to S303 of the multipath detecting method of this embodiment are the same as the Steps S101 to S103 in the first embodiment, and therefore, the description is omitted.

Moreover, in the multipath detecting method of this embodiment, first the existence of multipath is detected based only on individual measurement values. Specifically, the C/No(iv) and the determination threshold C/Noth(iv) are compared to each other, and the difference value DV(iv) and the determination threshold DVth(iv) are compared to each other. Moreover, if the C/No(iv) is above the determination threshold C/Noth(iv) and the difference value DV(iv) is below the determination threshold DVth(iv), it is determined that multipath does not exist (S304: YES→S310).

On the other hand, when either one of a condition in which the C/No (iv) is below the determination threshold C/Noth(iv) and a condition in which the difference value DV(iv) is above the determination threshold DVth(iv) is satisfied, it is determined that multipath exists in the determination based on the individual measurement values and shifts to the determination of the existence of multipath based on continuous values (S304: NO→S305).

Then, it is determined whether predetermined numbers of data of C/No (iv) and the difference values DV(iv) are acquired, respectively. Thus, it is determined whether the numbers of data corresponding to the sampling numbers for calculating the average value C/No(Av) and the standard deviation σ_{C/No} of the C/No and the average value DV(Av) and the standard deviation σ_{DV} of the difference values exist, respectively. Here, if the predetermined numbers of data cannot be acquired, it is defined to be indeterminable (5305: NO→S312).

On the other hand, if the predetermined numbers of data can be acquired (S305: YES), the average value C/No(Av) and the standard deviation σ_{C/No} of the C/No and the average value DV(Av) and the standard deviation σ_{DV} of the difference values are calculated (S306).

Next, a multipath determination threshold C/Noth(Av) for the average value C/No(Av) of the C/No and a multipath determination threshold σth_{C/No} for the standard deviation σ_{C/No} are set similarly to the method in the first embodiment. Moreover, a determination threshold DVth(Av) of the average value of the difference values and a determination threshold σth_{DV} of the standard deviation of the difference values are set similarly to the determination threshold DVth(iv) described above (S307).

Next, the average value DV(Av) of the difference values and the determination threshold DVth(Av) are compared to each other, and as well as the standard deviation σ_{DV} of the difference values and the determination threshold σth_{DV} are compared to each other. Further, if the average value DV(Av) of the difference values is below the determination threshold DVth(Av) thereof and the standard deviation σ_{DV} of the difference values is also below the determination threshold σth_{DV} thereof, it is determined that multipath does not exist based on the average value and the standard deviation of the difference values (S308: YES). On the other hand, if the average value DV(Av) of the difference values is above the determination threshold DVth(Av) thereof or the standard deviation σ_{DV} of the difference values is above the determination threshold σth_{DV} thereof, it is determined that multipath exists (S308: NO→S311).

Next, the average value C/No(Av) and the determination threshold C/Noth(Av) of the C/No are compared to each other, and as well as the standard deviation σ_{C/No} and the determination threshold σth_{C/No} of the C/No are compared to each other. Further, if the average value C/No(Av) of the C/No is below the determination threshold C/Noth(Av) thereof or the standard deviation σ_{C/No} of the C/No is below the determination threshold σth_{C/No} thereof, it is determined that multipath does not exist based on the average value and the standard deviation of the C/No (S309: YES) and ultimately it is determined that multipath does not exist (S310). On the other hand, if this condition is not satisfied, it is determined that multipath exists (S309: NO→S311).

Also with such a method, the existence of multipath can be detected. Further, by using the multipath detecting method of this embodiment, even when multipath is determined to exist due to the variation of the individual measurement values caused by factors other than multipath, it can be determined that multipath does not exist based on the continuous values (average value and standard deviation).

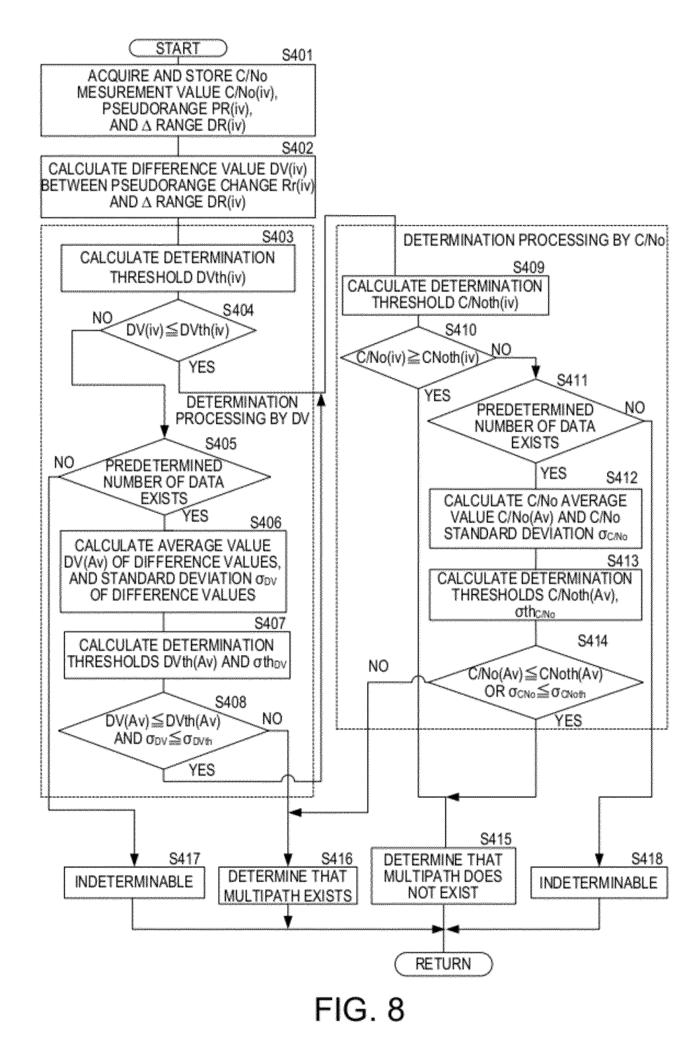

Next, a multipath detecting method according to a fourth embodiment is described with reference to a drawing. FIG. 8 is a flowchart of the multipath detecting method of this embodiment.

Steps S401 to S403 of the multipath detecting method of this embodiment are the same as the Steps S201 to S203 in the second embodiment, and therefore, the description is omitted.

Moreover, in the multipath detecting method of this embodiment, a determination of the existence of multipath is performed first based only on the difference value DV(iv). Specifically, the difference value DV(iv) and the determination threshold DVth(iv) are compared to each other, and if the difference value DV(iv) is below the determination threshold DVth(iv), it is determined that multipath does not exist and shifts to the determination of the existence of multipath based on the C/No (S404: YES). On the other hand, if the difference value DV(iv) is above the determination threshold DVth(iv), it is determined that multipath exists (S404: NO→S405).

Next, if it is determined that multipath exists based on the difference value DV(iv), a multipath determination based on continuous values is performed. First, it is determined whether a predetermined number of data of the difference values DC(iv) is acquired. Thus, it is determined whether the number of data corresponding to the sampling number for calculating the average value DV(Av) and the standard deviation σ_{DV} of the difference values exists. Here, if the predetermined number of data cannot be acquired, it is defined to be indeterminable (S405: NO→S417).

On the other hand, if the predetermined number of data can be acquired (S405: YES), the average value DV(Av) and the standard deviation σ_{DV} of the difference values are calculated (S406).

Further, a determination threshold DVth(Av) of the average value of the difference values and a determination threshold σth_{DV} of the standard deviation are set similarly to the determination threshold DVth(iv) described above (S407).

Next, the average value DV(Av) of the difference values and the determination threshold DVth(Av) are compared to each other, and as well as the standard deviation σ_{DV} of the difference values and the determination threshold σth_{DV} are compared to each other. Further, if the average value DV(Av) of the difference values is below the determination threshold DVth(Av) thereof and the standard deviation σ_{DV} of the difference values is also below the determination threshold σth_{DV} thereof, it is determined that multipath does not exist based on the determination of the continuous values of the difference values and shifts to the determination based on the C/No (S408: YES). On the other hand, if the average value DV(Av) of the difference values is above the determination threshold DVth(Av) thereof or the standard deviation σ_{DV} of the difference values is above the determination threshold σth_{DV} thereof, it is determined that multipath exists (S408: NO→S416).

Next, a multipath determination threshold C/Noth(iv) for the C/No (iv) is set similarly to the method in the first embodiment (S409).

Next, the C/No(iv) and the determination threshold C/Noth(iv) are compared to each other, and if the C/No(iv) is above the determination threshold C/Noth(iv), it is determined that multipath does not exist (S410: YES), and it is determined that multipath does not exist through the entire detection processing (S415).

On the other hand, if the C/No(iv) is below the determination threshold C/Noth(iv), it is determined that multipath exists based on the individual measurement values and shifts to the determination based on continuous values (S410: NO→S411).

First, it is determined whether a predetermined number of data of the C/No(iv) is acquired. Thus, it is determined whether the numbers of data corresponding to the sampling number for calculating the average value C/No(Av) and the standard deviation σ_{C/No} of the C/No exists. Here, if the predetermined number of data cannot be acquired, it is defined to be indeterminable (S411: NO→S418).

Next, an average value C/No(Av) and a standard deviation σ_{C/No} of the C/No are calculated (S412).

Next, a multipath determination threshold C/Noth(Av) for the average value C/No(Av) of the C/No and a multipath determination threshold σth_{C/No} for the standard deviation σ_{C/No} are calculated (S413).

Subsequently, the average value C/No(Av) and the determination threshold C/Noth(Av) of the C/No are compared to each other, and as well as the standard deviation σ_{C/No} and the determination threshold σth_{C/No} of the C/No are compared to each other. Further, if the average value C/No(Av) of the C/No is below the determination threshold C/Noth(Av) thereof or the standard deviation σ_{C/No} of the C/No is also below the determination threshold σth_{C/No} thereof, it is determined that multipath does not exist based on the determination of the average value and the standard deviation of the C/No (S414: YES) and ultimately it is determined that multipath does not exist (S415). On the other hand, if this condition is not satisfied, it is determined that multipath exists (S414: NO→S416).

Also with such a method, the existence of multipath can be detected accurately. Further, similar to the third embodiment, even when multipath is determined to exist due to the variation of the individual measurement values caused by factors other than multipath, it can be determined that multipath does not exist based on the continuous values (average value and standard deviation).

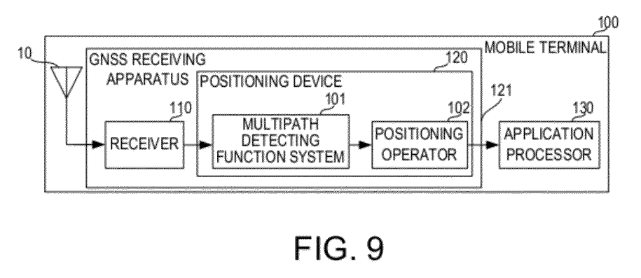

Note that, such a multipath detecting function system 1 as described above is used in, for example, a mobile terminal 100 having a positioning device 120 as shown in FIG. 9. FIG. 9 is a block diagram showing a main configuration of the mobile terminal 100 having the multipath detecting function of the invention.

The mobile terminal 100 as shown in FIG. 9 is, for example, a mobile phone, a car navigation system, a PND, a camera, or a watch, and includes an antenna 10, a receiver 110, the positioning device 120, and an application processor 130. The receiver 110 and the positioning device 120 constitute a GNSS receiving apparatus 121.

The antenna 10 is the same as the antenna shown in FIG. 5, and the receiver 110 is a function unit corresponding to the FR processor 11 and the baseband converter 12 of FIG. 5.

A multipath detecting function system 101 of the positioning device 120 corresponds to the multipath detecting function system 1 described above, and a positioning operator 102 of the positioning device 120 performs positioning of a position of the own device by using the multipath detection information, the pseudorange, a navigation message and the like, and outputs the positioning result to the application processor 130. Note that, the multipath detecting function system 101 and the positioning operator 102 function as the positioning device 120 and the positioning device 120 may be used as an independent device.

Based on the obtained positioning result, the application processor 130 displays the position of the own device and executes processing for being used in navigation, etc.

According to such a configuration, since a highly accurate multipath detection as described above is available, a pseudorange can be obtained in high accuracy. Moreover, by obtaining highly accurate positioning result, a highly accurate position display, navigation and the like can be achieved.

### DESCRIPTION OF NUMERALS

1 and 101: Multipath Detecting Function System; 10: Antenna; 11: RF Processor; 12: Baseband Converter; 13: Carrier Correlation Unit; 31: Carrier Correlator; 32: Loop Filter; 33: Carrier NCO; 14: Code Correlation Unit; 41P: P Correlator; 41E: E Correlator; 41L: L Correlator; 42: Adder; 43: Loop Filter; 44: Code NCO; 45: Shift Register; 15: Delta Range Measurer; 16: C/No Measurer; 17: Pseudorange Calculator; 18: Multipath Detector: 100: Mobile Terminal; 110: Receiver; 120: Positioning Device; 121: GNSS Receiving Apparatus; 102: Positioning Operator; and 130: Application Processor

1-10. (canceled)

11. A method of detecting multipath by outputting a detection signal indicating that a multipath signal is included in reception signals of GNSS positioning signals, comprising:
calculating a pseudorange based on a code phase difference of the reception signals;
measuring a Doppler shift of the reception signals; and
outputting the detection signal based on a change rate of the pseudorange within a predetermined period of time and the Doppler shift.

12. The multipath detecting method of claim 11, further comprising:
measuring for measuring a C/No of the reception signals,
wherein the outputting the detection signal includes outputting the detection signal based on a change rate of the pseudorange within a predetermined period of times, the Doppler shift, and the C/No.

13. The multipath detecting method of claim 12, wherein the outputting the detection signal includes outputting the detection signal when at least one of a difference value between the change rate of the pseudorange within the predetermined period of time and the Doppler shift, an average value of the difference values, and a standard deviation of the difference values is above a threshold based on the C/No.

14. The multipath detecting method of claim 13, wherein the threshold based on the C/No is a value based on the standard variation of the difference values corresponding to the C/No measured in advance.

15. The multipath detecting method of claim 12, wherein the outputting the detection signal includes outputting the detection signal when at least one of the C/No, a average value of the C/No, and a standard deviation of the C/No is above a predetermined value.

16. A GNSS receiving apparatus for performing a positioning based on reception signals of GNSS positioning signals, comprising:
a receiver for receiving the GNSS positioning signals;
a multipath detecting function system for outputting a multipath detection signal based on a change rate of a pseudorange calculated based on a code phase difference of the reception signals and a Doppler shift of the reception signal; and
a positioning operator for using the detection signal of multipath to perform a positioning operation by using the pseudoranges.

17. A GNSS receiving apparatus of claim 16, wherein the multipath detecting function system for outputting a multipath detection signal based on a change rate of a pseudorange calculated based on a code phase difference of the reception signals, a Doppler shift of the reception signals, and a C/No of the reception signals.

18. A mobile terminal, comprising:
the GNSS receiving apparatus of claim 16; and
an application processor for executing a predetermined application by using a positioning operation result from the positioning operator.
